(19) United States
(12) Patent Application Publication
(10) Pub. No.: US 2013/0026667 A1
(43) Pub. Date: Jan. 31, 2013

(54) TRAYS WITH DIFFERENTIATED DRILLINGS AS A DOUBLE-FUNCTION DEVICE FOR PACKED COLUMNS

(71) Applicant: Helio Rubens Taddei Ramos, Sao Paulo (BR)

(72) Inventor: Helio Rubens Taddei Ramos, Sao Paulo (BR)

(73) Assignee: UTC ENGENHARIA S/A, Chacara Santo Antonio (BR)

(21) Appl. No.: 13/574,408

(22) PCT Filed: Nov. 10, 2010
(86) PCT No.: PCT/BR10/00374

§ 371 Date: Sep. 21, 2012

(30) Foreign Application Priority Data
Jan. 20, 2010 (BR) PI1000186-7

(51) Int. Cl. B01D 3/22

(52) U.S. Cl. 261/113

(57) ABSTRACT

The object of the present patent application refers to a contact device with double function for packed columns, acting as a phase distributor and contactor, characterized by differentiated drills in approximately uniform distribution, as obtained by means of stamping of metal trays.

The object of the present patent application refers to a tray without downcomers with differentiated drillings performing the double function of distributor and phase contactor for packed columns. The present invention is particularly useful for packed columns with small diameters, especially if there are solids in the liquid current.

### STATE OF THE ART

In distillation, extraction and absorption processes, the two large groups of devices which are most used in the mass and energy transfer are trays and packings. Among the trays, the most common types are those with bubble cap, valves and perforated, all of them with downcomers. There is a much simpler and more economic type of tray which is perforated tray without downcomers. As we can see on reference 2 (J. A. Garcia and J. R. Fair—Distillation Trays without Downcomers: Prediction of Performance Characteristics, Ind. Eng. Chem. Res.—2002, 41, 1632 to 1640), trays without downcomers have large resistance against deposits. This is due to the non-existance of dead zones on the trays, which are self-draining. However, this kind of tray is only used in special cases, since its efficiency is very low. According to reference 3 (R. H. Weiland—Hydraulic Stability of Dual Flow Trays, AIChE Spring National Meeting, Apr. 25, 2001, New Frontiers in High Capacity Tray Technology), in this kind of tray, there is a dynamic wherein each hole alternatively pass vapor or liquid and, even when the tray is perfectly leveled, the liquid tends to go down through large groups of holes, randomly traveling through the tray surface and slowly dividing to form new groups. When the tray is not level, the bad distribution as indicated previously becomes almost static with vapor and liquid passing through opposed regions in the column. These behaviors are the cause of low efficiency in the mass and energy transfer presented by this kind of device. Packings are divided into randomic and structured. In columns with small diameter, the difficulties in assembly and maintenance of the trays, leads to a preference for the use of packings to promote the contact between liquid and vapor. A packed column is composed by the following devices:
a distributor or re-distributor collecting the liquid and distributing it to the packed bed below, with full separation of liquid and vapor currents;
a packed bed to promote the contact between liquid and vapor; and
a support or distributor for the packed bed.

As indicated in reference 1 (G. R. Martin and A. W. Sloley—Modern Glycol Dehydration Unit Design, Canadian Chemical Engineering Conference, Calgary, Alberta, Oct. 2-5, 1994), Gas Processing Symposium, Section V: Dehydration/Hydrates/Others), the key for packing performance is a good distribution of the liquid over the packed bed of the columns. Industrial practice has been the use of pan or channel-type distributors, examples of which can be seen on FIGS. 1 and 2 of reference 1.

The distributor of FIG. 1, with simpler construction, is especially indicated for columns with small diameter, but they have problems with the deposition of solids eventually present in the liquid streams. On the other hand, the Channel-type distributor has limitations for its application in columns with small diameter, but is highly resistant against the deposition of solids.

### BRIEF DESCRIPTION OF DRAWINGS

The present patent application will be better understood in the light of the attached figures, given as mere examples, but not limiting the scope of the present invention, wherein:

FIG. 1—pan-type distributor;

FIG. 2—channel-type distributor;

FIG. 3—typical stamping profiles;

FIG. 4—cut view of metal trays showing the shape of the holes for stamping with drilling and pulling actions;

FIG. 5—detail of a square arrangement, with flow direction preference, alternating between diagonals;

FIG. 6—detail of a triangular arrangement, reversing the flow direction preference in the center of beehives;

FIG. 7—detail of a square arrangement, with flow direction preference alternating between direction 1 on the line and 50% direction 1 and 50% direction 2 on the other line; and

FIG. 8—detail of a triangular arrangement, reversing the flow direction preference in ⅓ of the center of beehives.

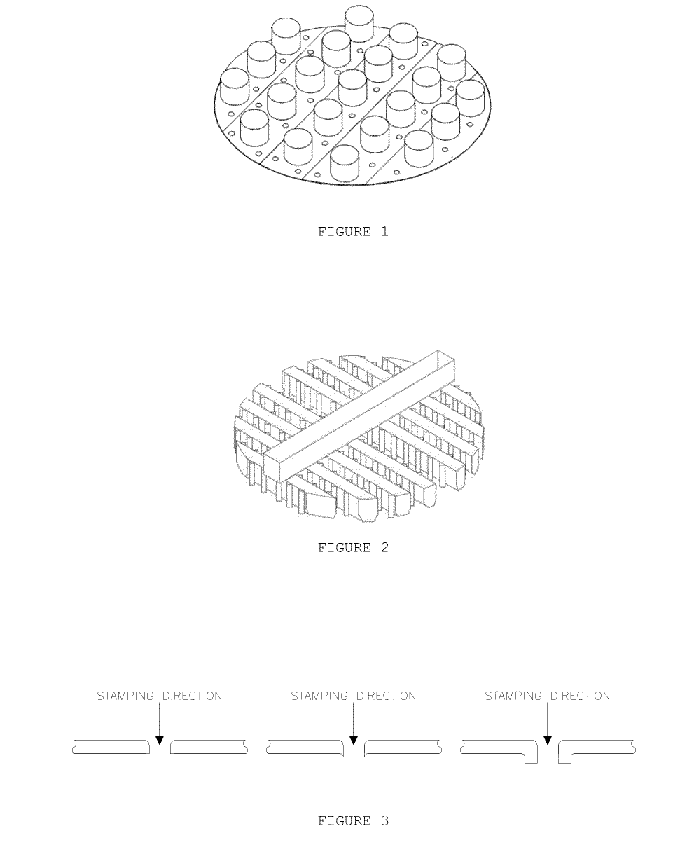

### EXPLANATION OF THE INVENTION

The present invention uses, in an innovative way, the tray without downcomers and with differentiated drillings as a double-function device in packed columns, performing as: Distributor: collection of phases and their distribution to the packed bed.

Contact device between phases, promoting the mass and energy transfer.

Another unique characteristic of this invention solves the apparently insoluble problem of bad phase distribution of trays without downcomers as indicated by reference 3 (mentioned above), since the basic function of a distributor is to avoid and correct the bad distribution in the column. This invention makes use of the surprising effect that, for stamped holes, the flow coefficient is higher in the direction of stamping. The reason for this effect can be seen in the typical profiles of drilling by stamping, as we can see on FIG. 3.

However, the simple change of the flow resistance coefficient of the drilling according to the flow direction, as provided by the two profiles on the left of FIG. 3, is unable to solve the problem of bad distribution. The present invention solves this problem by making use of an innovative way of the profile as created by a stamping operation with drilling and pulling, to create a profile as indicated by the drawing on the right of FIG. 3. The tab created by this operation changes in a different way the driving force for the flow of each phase and combined with an adequate distribution of the drill directions is able to solve the problem of bad distribution.

This property is used by the present invention to innovatively reduce the negative characteristics of flow distribution of phases as presented by the perforated devices without downcomers, thus reducing the randomicity and group formation in phase passage through the holes, minimizing unleveling effects, making viable its use as distributors for packed columns and continuing to promote mass and energy transfer between the phases. This device is constituted by:
a) metal tray;
b) tray drillings made by a stamping device, including drilling and pulling operations;
c) part of the holes with stamping in the same flow direction of the heavy phase and part of the holes with stamping in the same flow direction of the light phase. In some cases, part of the drillings wherein the flow direction practically does not affect the flow coefficient could also be used.
d) arrangement and direction of stamping so to reach uniform distributions without large distortions along the tray.

Preferably, the fraction of holes stamped in the flow direction of the light phase should be as near as possible to the fraction of holes through which the light phase will pass. The fraction of holes through which the light phase passes may be calculated by different methods, such as presented by reference 2 above.

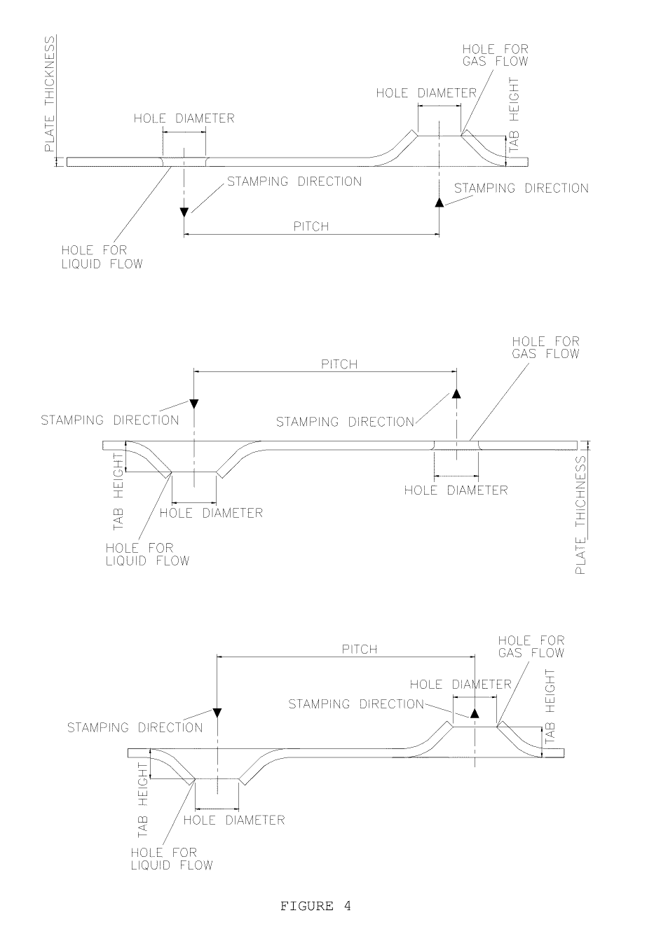

Preferably, the stamping should produce circular holes; preferably with a diameter between 1 mm and 50 mm. For better results, we recommend the use of a diameter between 12.5 and 25 mm. The combinations of type of stamping with differentiated holes for the passage of liquid and gas are exemplified by FIG. 4.

Since the column diameter will be calculated as a function of the selected packing, the pitch of the hole arrangement shall be preferably defined by the sizing of the tray as a contact device between phases, perforated tray with no downcomer type, such as indicated by reference 2 above.

Preferably, the drilling of metal trays shall follow triangular or square arrangement.

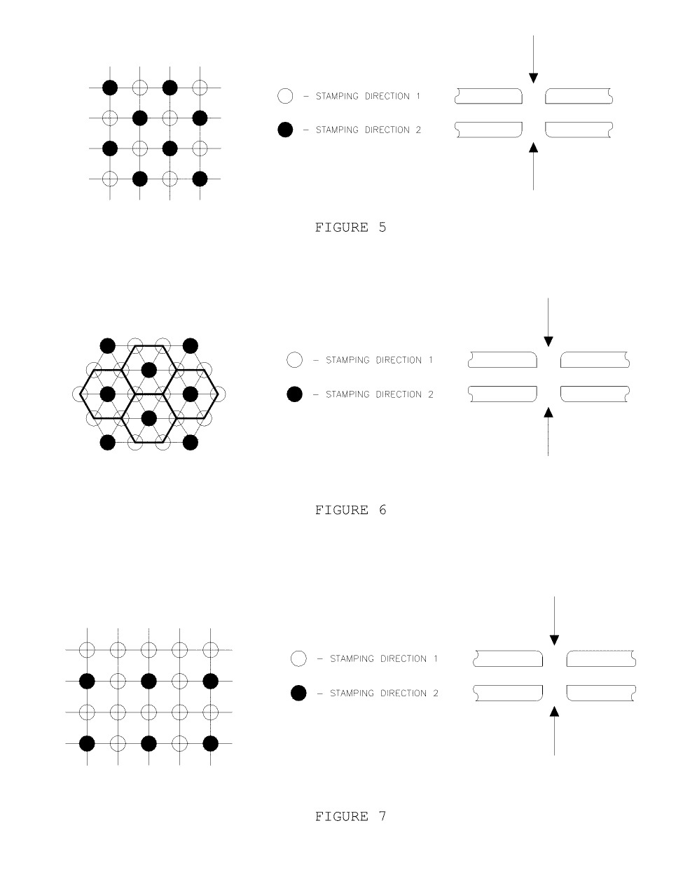

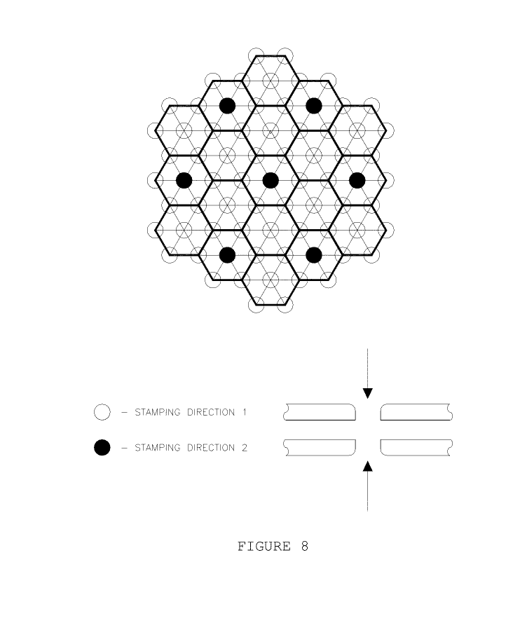

For better results, we recommend to estimate the fraction of holes through which each phase will pass and adopt, from the arrangements as suggested below, the one having a fracion which is the closest one to these calculated parameters.
a) Square arrangement, with flow direction preference alternating between diagonals, as shown by FIG. 5.
   Approximate distribution of drilling as presented:
50% in direction 1
50% in direction 2
   b) Triangular arrangement, reversing the flow direction preference in the center of beehives, as shown by FIG. 6.
      Approximate distribution of drilling as presented:
67% in direction 1
33% in direction 2
   c) Square arrangement with flow direction preference alternating between direction 1 on the line and 50% direction 1 and 50% direction 2 on the other line, as shown by FIG. 7.
      Approximate distribution of drilling as presented:
75% in direction 1
25% in direction 2
   d) Triangular arrangement reversing the flow direction preference in ⅓ of the center of beehives, as shown by FIG. 8.
      Approximate distribution of drilling as presented:
89% in direction 1
11% in direction 2

It should be highlighted that the proportions of drillings as mentioned in the above figures are inverted by inverting the assembly position of the trays.

In cases where the operation conditions and liquid-vapor phase ratio are very variable or unknown, the recommended configuration is a distribution by using stamped holes in direction 1, stamped holes in direction 2 and non-stamped holes supplying symmetrical coefficients. In this case, a triangular arrangement of the drills with each triangle having a drilling of each kind should be preferably used.

In case of use of the device with structured packings, preference should be given to assembly arrangements avoiding the coincidence between the drilling lines and the direction of trays of the structured packing. The stamping method has also an important function in this invention, since, the larger the difference between the flow coefficients and driving force in the stamping directions, the larger will be the effect on distribution and performance improvement of the double-function device. In the types of stamping profiles as shown by FIG. 3, the increase in the difference between flow coefficients and driving force in both directions of flow occurs from the left figure to the right figure. We should also notice that the present invention does not change the characteristics of easy assembling, low cost and resistance against deposits of perforated trays without downcomers, making this invention particularly useful in case of columns with small diameter and/or in the presence of solids in the liquid current. Although the preferred configurations of the present invention are disclosed in detail herewith, the experts in the art should understand that variations can be done not escaping from the scope of the present invention or the object of its claims.

1. Double-function distributor for separation or reaction processes in packed columns, acting as a distributor of liquid and promoting contact and mass and energy transfer between phases, assembled above random or structured packings, comprising a perforated tray without downcomers, assembled in one single part or in sections so to result in an assembled set with equal or slightly lower diameter than the column, built from metal trays, having holes obtained by a drilling and pulling method resulting in distinct profiles with a flow preference as a function of a flow direction, said holes partially benefiting a heavy phase flow; wherein the a geometric arrangement of said drillings has uniform distribution of different kinds of drillings along the device.

2. Double-function device of claim 1, wherein combinations in which part of the drillings benefit the flow of one of the phases and part of the drillings does not affect the flow coefficient can also be used.

3. Double-function device of claim 1, wherein a fraction of holes benefiting the flow of each phase should be as near as possible to the fraction of holes through which this phase will pass.

4. Double-function device of claim 1, wherein the device is adapted to cases of large variations in flow relations between a light phase and the a heavy phase, with distribution of drills including three kinds of drillings, being one to benefit the flow of the light phase, another benefiting the flow of the heavy phase and a third one not benefiting the flow of any phase.

5. Double-function device of claim 1, wherein the drilling process provides circular holes; with a diameter between 1 mm and 50 mm.

6. Double-function device of claim 1, further comprising a double-function distributor with circular holes with a diameter between 12.5 mm and 25 mm.

7. Double-function device of claim 1, wherein the drilling of trays follows a triangular or square arrangement.

8. Double-function device of claim 7, comprising a triangular arrangement of the holes, with the holes benefiting the flow in a first direction with approximately 67% or 89% of the total flow, and benefiting a flow in the opposite direction in about 33% or 11%, respectively.

9. Double-function device of claim 7, comprising a square arrangement of the holes, with the holes benefiting the flow in a direction with approximately 50% or 75% of the total flow, and benefiting a flow in the opposite direction in about 50% or 25%, respectively.
